(19) United States
(12) Patent Application Publication
(10) Pub. No.: US 2025/0139495 A1
(43) Pub. Date: May 1, 2025

(54) SELECTIVELY SHARED CONDENSED DATA FOR EFFICIENT FEDERATED LEARNING

(71) Applicant: Capital One Services, LLC, McLean, VA (US)

(72) Inventors: Michael DAVIS, Arlington, VA (US); Galen RAFFERTY, Mahomet, IL (US); Samuel SHARPE, Cambridge, MA (US); Brian BARR, Schenectady, NY (US); Jeremy GOODSITT, Champaign, IL (US); Taylor TURNER, Richmond, VA (US); Kenny BEAN, Herndon, VA (US); Owen REINERT, Queens, NY (US); Tyler FARNAN, San Diego, CA (US)

(73) Assignee: Capital One Services, LLC, McLean, VA (US)

(21) Appl. No.: 18/494,920

(22) Filed: Oct. 26, 2023

(51) Int. Cl. G06N 20/00

(52) U.S. Cl. CPC G06N 20/00

(57) ABSTRACT

A method and related system for training a machine learning model using a federated learning structure by selectively sharing condensed data between devices includes operations to obtain datasets from client devices comprising a first client device and a second client device and updating a datasets subset to comprise a first dataset. The method further includes updating the datasets subset to comprise a second dataset based on a result indicating that a feature space distance between the first dataset and the second dataset satisfies a set of criteria and sending, to a third client device, the datasets subset comprising the first dataset and the second dataset. The method further includes obtaining, from the third client device, a set of model parameters that is derived from training based on the datasets subset and updating a server version of a machine learning model based on the set of model parameters.

### SUMMARY

In a federated learning structure, multiple decentralized devices having their own local data may train local versions of models based on their respective local data. These multiple decentralized devices may then provide their respective model parameters or updates to the respective model parameters to a server or other set of computing devices. Such an architecture may inhibit unnecessary transfers in local data and provide various benefits in the areas of data privacy, data security, scalability, and reduced latency.

In many cases, the mere long-term storage of datasets for training operations may pose security risks. Some systems may cause client devices to share condensed data with each other and train a machine learning model to predict outcomes using the shared condensed data. However, the shared condensed data is often duplicative and may cause overfitting problems because the shared condensed data would often not include condensed datasets representing the datasets associated with a minority of events. Furthermore, the use of duplicative condensed data during training operations in a federated architecture may significantly increase the amounts of energy consumed. Such energy consumption may cause a corresponding increase in the amount of greenhouse gases being generated from energy-producing operations.

Some embodiments may overcome the technical issue described above or other issues by providing parameters of a machine learning model to a plurality of client devices. These machine learning model parameters may include weights, activation function parameters, biases, etc. After receiving the machine learning model parameters, a client device may perform data condensation operations to generate a condensed dataset that is pertinent to the machine learning model. Some embodiments may receive a plurality of condensed datasets, where each condensed dataset may be provided by a different client device.

Some embodiments may select a subset of condensed datasets for transfer to multiple client devices for training operations. For example, some embodiments may update the subset of the condensed datasets representing target datasets for transfer to other devices to include a first dataset from a first client device. After obtaining a second dataset from a second client device, some embodiments may determine whether the second dataset should be included in this subset of condensed datasets for transfer to other client devices. For example, some embodiments may determine whether a feature space distance between the first condensed dataset and the second condensed dataset exceeds a threshold, where exceeding the threshold may indicate that the first and second datasets are sufficiently different to provide diverse datasets for training operations.

Some embodiments may then send an updated selected subset of condensed datasets to the first client device, the second client device, or a third client device. Each respective client device of the set of devices that received the subset of condensed datasets may train their respective local models based on the selected subset of condensed data sent to the prospective client device. Each client device may send data derived from their respective training operations, such as model parameters or updates to their respective model parameters. A server or other central computing system may obtain these sets of model parameters derived from training from the client computing devices and update a server-side version of the machine learning model based on the obtained parameters. In some embodiments, the selection of specific datasets for distribution for federated training operations may result in a more efficient training operation by ensuring a variety of datasets and a reduction of duplicative training. Such efficiency may be especially useful in lower-resource computing environments, such as local client devices. Additionally, reducing amount of duplicative training in a federated architecture may reduce the energy consumption of distributed machine learning operations. Such gains in energy conservation may be tremendous when scaled to tens of thousands, hundreds of thousands, or millions of computing devices, which would cause a corresponding reduction in any greenhouse gases that would have been emitted when producing this energy.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

Detailed descriptions of implementations of the present technology will be described and explained through the use of the accompanying drawings.

FIG. 1 illustrates an example of a system to select datasets and train a machine learning model, in accordance with some embodiments.

FIG. 2 illustrates an example federated system, in accordance with some embodiments.

FIG. 3 is a flowchart of a process for training a federated learning model by selectively determining datasets from different systems, in accordance with one or more embodiments.

FIG. 4 is a flowchart of a process for training a learning model with a client device that was provided with selectively determined condensed datasets, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

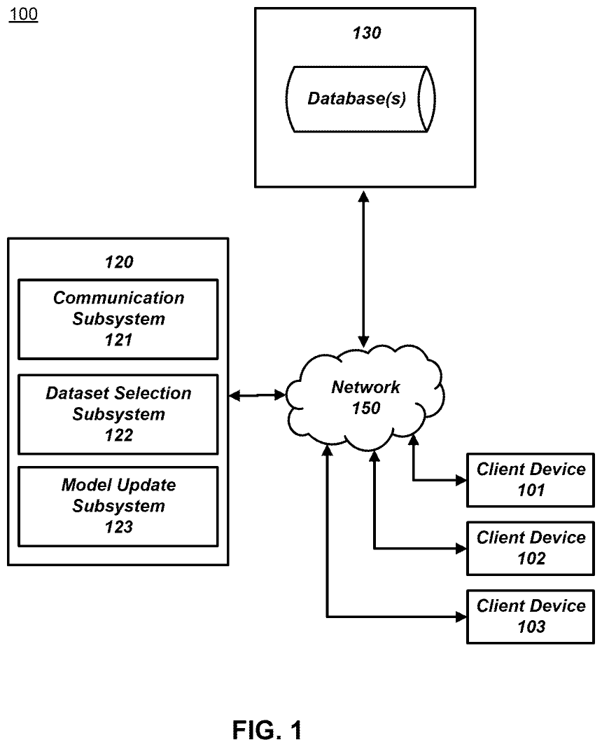

FIG. 1 illustrates an example of a system to select datasets and train a machine learning model, in accordance with some embodiments. A system 100 includes a set of client devices 101-103. The set of client devices 101-103 may include computing devices such as a desktop computer, a laptop computer, a wearable headset, a smartwatch, another type of mobile computing device, a transaction device, etc. In some embodiments, the first client device 101 may communicate with various other computing devices via a network 150, where the network 150 may include the internet, a local area network, a peer-to-peer network, etc. The first client device 101 may send and receive messages through the network 150 to communicate with a set of servers 120, where the set of servers 120 may include a set of non-transitory storage media storing program instructions to perform one or more operations of subsystems 121-123.

While one or more operations are described herein as being performed by particular components of the system 100, those operations may be performed by other components of the system 100 in some embodiments. For example, one or more operations described in this disclosure as being performed by the set of servers 120 may instead be performed by the first client device 101. Furthermore, some embodiments may communicate with an application programming interface (API) of a third-party service via the network 150 to perform various operations disclosed herein, such as retrieving a machine learning model, updating a machine learning model, or distributing model parameters of a machine learning model, where the machine learning model may include various types of prediction models, categorization models, etc. For example, some embodiments may retrieve a neural network model parameter via an API by communicating with the API via the network 150.

In some embodiments, the set of computer systems and subsystems illustrated in FIG. 1 may include one or more computing devices having electronic storage or otherwise capable of accessing electronic storage, where the electronic storage may include the set of databases 130. The set of databases 130 may include values used to perform operations described in this disclosure. For example, the set of databases 130 may store machine learning model parameters, training data, model parameters corresponding with different models, etc.

In some embodiments, a communication subsystem 121 may receive or send messages from various types of information sources or data-sending devices, including the client devices 101-103. For example, the communication subsystem 121 may send model parameters of a machine learning model to the first client device 101, the second client device 102, and the third client device 103. Alternatively, or additionally, the communication subsystem 121 may receive a plurality of condensed datasets or other types of data from the client devices 101-103. As described elsewhere in this disclosure, one or more client devices may be part of a federated learning structure in which each prospective client device may be provided with or may otherwise store a local version of a machine learning model. A client device may use local data stored on the client device to train the local version of the machine learning model, where the local data may include user-specific information, account-specific information, transaction information, visited websites or other Internet destinations, etc. In some embodiments, the client device may act as a data-receiving device to receive instructions, a configuration parameter, or other data that causes the data-receiving device to condense a dataset for training operations and provide the condensed dataset to a server, where the condensed dataset is received by the communication subsystem 121.

Furthermore, the communication subsystem 121 may send selected subsets of datasets to one or more of the client devices 101-103. For example, the first client device 101 and the second client device 102 may both provide condensed datasets that are selected for inclusion in a subset of datasets. The communication subsystem 121 may then send the subset of datasets to the third client device 103. The third client device 103 may then provide deltas or other types of update information indicating changes to model parameters to the communication subsystem 121.

In some embodiments, dataset selection subsystem 122 may select a subset of datasets from a plurality of datasets provided by client devices or other data-sending devices. For example, some embodiments may determine whether a condensed dataset is sufficiently different from other datasets to be used for federated training operations. If a candidate dataset is determined to be sufficiently different, some embodiments may select the candidate dataset for inclusion in a subset of datasets indicated for distribution.

The dataset selection subsystem 122 may use various types of criteria to select datasets for distribution to other client devices to train a federated learning model. Some embodiments may use one or more criteria to select datasets that are different from each other in order to reduce redundant training operations. For example, some embodiments may obtain a first condensed dataset from the first client device 101, a second condensed dataset from the second client device 102, and a third condensed dataset from the third client device 103. The dataset selection subsystem 122 may determine that no datasets have been selected for distribution yet and, in response, generate a subset of condensed datasets for distribution to the client devices 101-103 and include the first condensed dataset in the subset of condensed datasets for distribution. The dataset selection subsystem 122 may then determine a first distance in feature space (“feature space distance”) as an indicator of difference between the first condensed dataset and other condensed datasets. Based on a determination that the first feature space distance between the first condensed dataset and the second condensed dataset exceeds a difference threshold, the dataset selection subsystem 122 may update the subset of condensed datasets to include the second condensed dataset. Furthermore, the dataset selection subsystem 122 may determine a second feature space distance between the first and third condensed dataset and determine that the second feature space distance does not exceed the difference threshold. In response to a determination that the second feature space distance does not exceed the difference threshold, the dataset selection subsystem 122 may exclude the third condensed dataset from the subset of condensed datasets. By selecting the first condensed dataset and the second condensed dataset for inclusion in a subset of condensed datasets to be distributed to computing devices of a federated learning structure, some embodiments may increase the likelihood that the computing devices will be trained for different scenarios.

A model update subsystem 123 may perform operations to update a federated learning model. As discussed elsewhere in this disclosure, one or more client devices may receive a subset of condensed datasets. After receiving the subset of condensed datasets, the client device may perform training operations to update a local machine learning model based on the subset of condensed datasets, where the training will update machine learning model parameters (or other prediction model parameters). In some embodiments, the client devices may then provide the updated machine learning model parameters to the set of servers 120 or data derived from the updated machine learning models, such as numeric values indicating changes to one or more machine learning model parameters. After obtaining one or more sets of learning model parameters derived from the local training performed by a client device, some embodiments may then update a server-side version of the machine learning model using the perceived parameters or parameter-derived data. For example, after receiving a first set of learning model parameters represented by the first array “[0,5, 0.2, 0.4]” and a second set of learning model parameters represented by the second array “[0.9, 0.0, 0.2],” some embodiments may modify the original values of the learning model parameters based on an average of the first and second array, “[0.7, 0.1, 0.3].”

By updating a model using multiple datasets from different devices, client computing resources can be used to train or otherwise update model in a way that accounts for data entropy and variation in client data. Such utilization can reduce the computational resource requirements of a server-side system when updating a server-side version of a model. Furthermore, selective distribution can increase the likelihood that a client computing device will be used to efficiently account for data variation instead of being redundantly used to train a model with similar datasets that would not increase the accuracy of the model. By eliminating redundant training operations, more than 5%, more than 10%, more than 50%, or even more than 90% of amount of local training may be avoided. Moreover, the elimination of such redundancy may result in dramatically reducing energy expenditure in a federated learning environment, where such reduced energy expenditure would cause a direct reduction in any greenhouse gases that would have been emitted to produce this energy. The environmental impact of such greenhouse gas emission reduction during these training operations may be significant when scaled to a large population of devices and their respective datasets.

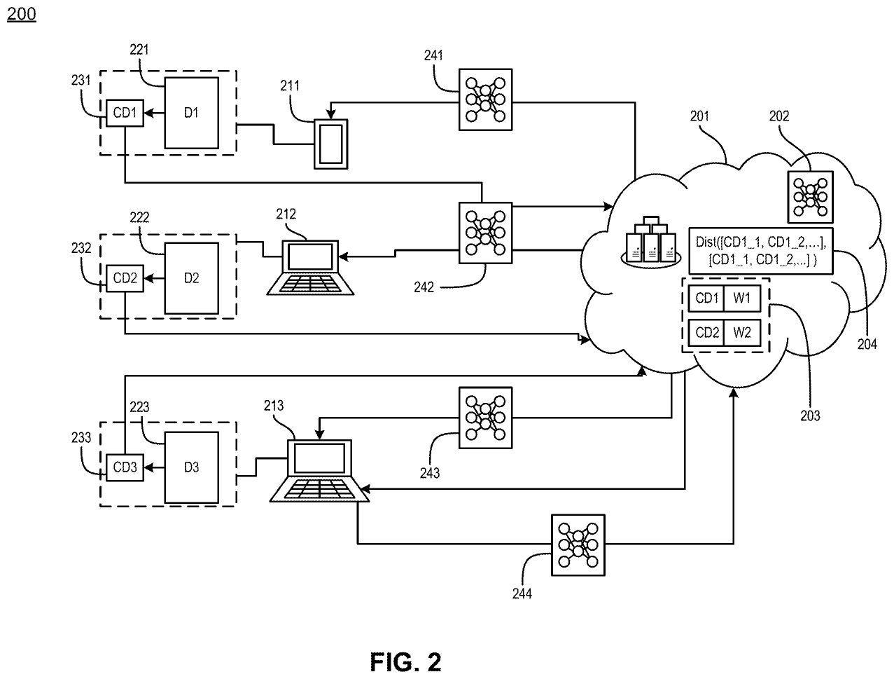

FIG. 2 illustrates an example federated system, in accordance with some embodiments. The system 200 shows a cloud server system 201, where the cloud server system 201 may perform one or more operations described in this disclosure. Alternatively, or additionally, other server systems may be used, such as a server executing on an on-premises cluster of devices. In some embodiments, the cloud server system 201 may send learning model parameters to a first client device 211, a second client device 212, and a third client device 213, where the learning model parameters may be obtained from a server-side learning model 202. The model parameters may be used to configure or update a first local learning model 241 stored on the first client device 211, a second local learning model 242 stored on the second client device 212, and a third local learning model 243 stored on the third client device 213. Some embodiments may send all of the model parameters of a machine learning model to configure the machine learning model. For example, in some embodiments, the cloud server system 201 may provide all of the weights, biases, and activation function parameters for a neural network to the first client device 211. Alternatively, in some embodiments, the cloud server system 201 may provide a subset of the model parameters of a machine learning model. For example, the cloud server system 201 may send only model parameters of a first layer or a neural network to the second client device 212.

The first client device 211 may condense a local dataset 221 into a first condensed dataset 231. Various types of data condensation operations may be used and may depend on the type of data being condensed. For example, some embodiments may provide an application to the first client device 211 that causes the first client device 211 to condense database transaction information by sampling the database transactions, aggregating the database transactions for a provided time period, binning the transaction information into transactions for pre-configured time intervals, dimensionally reducing the transaction information, etc. Other types of data condensation operations may be performed. For example, some embodiments may convert natural language statements into a set of tokens and then convert the set of tokens into a set of vectors in a vector space. Some embodiments may then dimensionally reduce the set of vectors using various dimensional reduction techniques, such as principal component analysis, linear discriminant analysis (LDA), or through the use of auto encoder neural networks. For example, in some embodiments, the first client device 211 may use a set of auto encoder neural networks to convert the first local dataset 221 into the first condensed dataset 231. Similarly, the second client device 212 may use auto encoders, Principal Component Analysis (PCA), or another dimensional reduction method, or another data condensation method to generate a second condensed dataset 232 using the second local dataset 222. Similarly, the third client device 213 may use a data condensation method to generate a third condensed dataset 233 using the third local dataset 223.

After generating the first condensed dataset 231, the first client device 211 may then send the first condensed dataset 231 to the cloud server system 201. Similarly, after generating the second condensed dataset 232, the second client device 212 may then send the second condensed dataset 232 to the cloud server system 201. Furthermore, after generating the third condensed dataset 233, the third client device 213 may then send the third condensed dataset 233 to the cloud server system 201.

After receiving the first condensed dataset 231, the cloud server system 201 may determine whether a subset of condensed datasets is already being stored. The cloud server system 201 may determine that no condensed datasets have been designated for distribution in the system 200 and, in response, update the subset of condensed datasets 203 by generating the subset of condensed datasets 203, where the subset of condensed datasets 203 initially includes only the first condensed dataset 231. The cloud server system 201 may then determine whether additional datasets received are sufficiently different from the datasets of the subset of condensed datasets 203 in order to determine whether to include the additional dataset in the subset of condensed datasets 203. For example, the cloud server system 201 may then determine whether to include the second condensed dataset 232 based on the difference value 204. For example, the cloud server system 201 may compare the difference value 204 with a threshold and, if the difference value 204 is greater than or equal to the threshold, include the second condensed dataset 232 in the subset of condensed datasets 203. The cloud server system 201 may further determine difference values between the third condensed dataset 233 and both the first condensed dataset 231 and the second condensed dataset 232 to determine a second difference value and third difference value, respectively. The cloud server system 201 may then determine a result that at least one of the difference values does not satisfy the threshold and, in response, not include the third condensed dataset 233 in the subset of condensed datasets 203.

Furthermore, some embodiments may bin different condensed datasets into categories. For example, the cloud server system 201 may cluster each of the condensed datasets 231-233 and other condensed datasets provided by other client devices. The cloud server system 201 may then select a synthetic dataset (e.g., a centroid dataset) or an actual dataset from one or more detected clusters to include the subset of condensed datasets 203. Furthermore, some embodiments may include weights with the subset of condensed datasets 203 indicating a number of datasets detected to share a cluster with the provided datasets of the subset of condensed datasets 203. For example, some embodiments may perform a clustering operation using a density-based clustering method that indicates that the first condensed dataset 231 is part of a first cluster in a feature space and that the second condensed dataset 232 is part of a second cluster in the feature space. The subset of condensed datasets 203 is shown to include the weight W1 in association with a version of the first condensed dataset 231 stored in the subset of condensed datasets 203, where W1 is a count of the datasets indicated to be in the same cluster as the first condensed dataset 231. Similarly, the subset of condensed datasets 203 is shown to include the weight W2 in association with a version of the second condensed dataset 232 stored in the subset of condensed datasets 203, where W2 is a count of the datasets indicated to be in a same cluster as the second condensed dataset 232.

The cloud server system 201 may send the subset of condensed datasets 203 to one or more client devices of the system 200. For example, the cloud server system 201 sends the subset of condensed datasets 203 to the third client device 213. The third client device 213 may then retrain a machine learning model using the subset of condensed datasets 203 to determine the updated machine learning model 244. The third client device 213 may then send the updated machine learning model 244 to the cloud server system 201, which may then update the server-side learning model 202.

Various types of learning models may be used, such as a neural network, a random forest, support vector machines, etc. The machine learning models described in this disclosure may include one or more various types of learning models may be used, such as a neural network (e.g., a recurrent neural network, transformer neural network, ensemble network, etc.), a random forest, support vector machines, etc. Furthermore, a machine learning model may be used on the context of various types learning architecture, such as reinforcement learning architecture. Additionally, while embodiments describe machine learning models, it should be understood that statistical models or other types of models may be used to output labels, provide predictions, or be re-configured based on a comparison between model outputs and training data or data obtained from another data source.

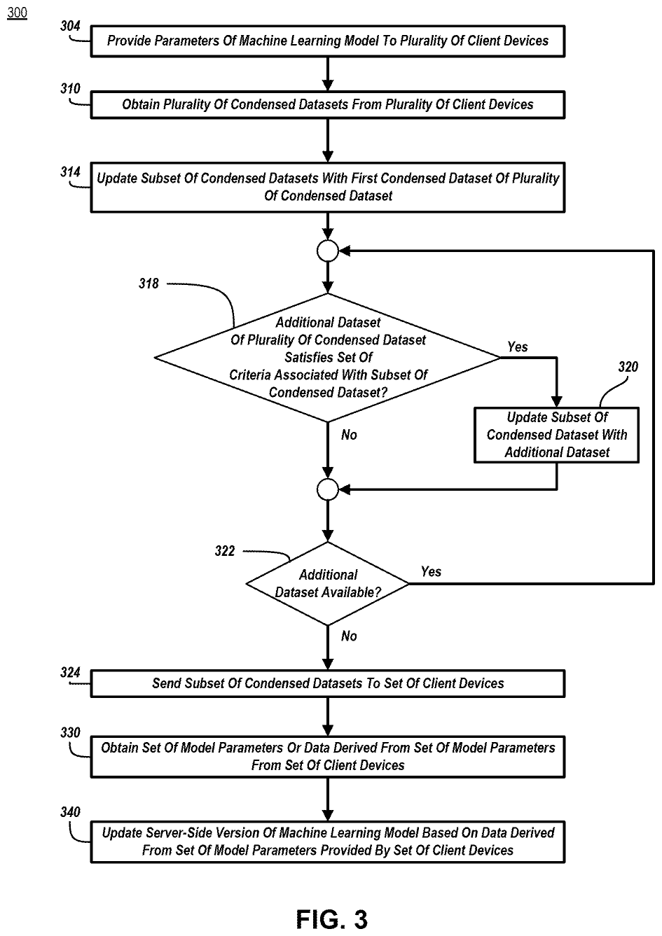

FIG. 3 is a flowchart of a process 300 for training a federated learning model by selectively determining datasets from different systems, in accordance with one or more embodiments. Some embodiments may provide parameters of a machine learning model to a plurality of client devices, as indicated by block 304. A server or other computing system may provide machine learning model parameters of a machine learning model to a set of client devices. In some embodiments, the machine learning model may be pre-trained based on an initial set of records that are not provided in their condensed form. Alternatively, the machine learning model may be pre-trained based on a set of condensed records obtained from a history of condensed records. For example, as described elsewhere, client devices may use a binning method or another condensation method to reduce a sequence of values into a set of binned values and send the set of binned values to a server. This set of binned values may be stored in a database of condensed data for use as training data. Some embodiments may then pre-train a neural network value using the set of binned values.

In some embodiments, a client device may be configured to generate condensed data in response to receiving a model or some other type of data from a server. A client device may store various types of data and may use various methods to condense the various types of data. A server may transmit instructions to a client device indicating what subset of data to condense and the operations that the client should perform to condense the indicated subset of data. For example, a server may send a set of machine learning model parameters and a set of configuration parameters or program instructions indicating a data condensation method to a client device. The set of configuration parameters or program instructions may cause the client device to condense local data stored on the device or otherwise accessible to the device using a pre-configured condensation method or using a condensation method indicated by the set of configuration parameters or program instructions. For example, some embodiments may send program instructions to a client device that cause the client device to obtain locally stored data that includes a sequence of vectors in a latent space representing a token sequence. Some embodiments may then condense the token sequences using a dimension-reducing operation, such as PCA, to generate a condensed dataset. As described elsewhere in this disclosure, the client device may send the generated condensed dataset to a server or other computing system, where some embodiments may then use the generated condensed dataset to perform other operations of the process 300.

Some embodiments may obtain a plurality of condensed datasets from the plurality of client devices, as indicated by block 310. As described elsewhere, client devices may be configured to condense a local dataset, where the condensed dataset may be characterized as requiring less data to store than the respective uncondensed dataset from which it was generated. Some embodiments may send a request from a server to a client device, where the client device may then send a response message to the server that includes a condensed dataset generated by the client device. Alternatively, or additionally, a client device may be configured to push a message containing the condensed dataset to the server without requiring a request from the server. Furthermore, some embodiments stochastically send a command to a plurality of client devices to obtain condensed data. For example, some embodiments may stochastically broadcast a request from a server, where a plurality of client devices receiving the broadcasted request may respond by transmitting a plurality of condensed datasets generated by the plurality of client devices. Alternatively, some embodiments may limit the number of requests to a subset of client devices. For example, some embodiments may generate different subsets of condensed data, where each subset of condensed data may be targeted for different subsets of a receiving device. Some embodiments may multicast a request for data from a server to a first subset of client devices without sending the request to a second subset of client devices. In response, the first subset of client devices may send condensed datasets back to the server. Some embodiments may select different subsets of devices or otherwise determine different subsets of devices to send or receive data from based on a shared geographic region, a shared demographic category associated with user records associated with the subset of devices, shared transaction data, etc. For example, some embodiments may select client devices that are within a distance threshold of each other, where the distance threshold may be equal to a value less than 1.0 kilometers, a value less than 10.0 kilometers, a value less than 100.0 kilometers, a value less than 1,000 kilometers, etc.

In some embodiments, one or more client devices may add one or more noise values to a condensed dataset before sending the condensed dataset to a server. For example, a client device may first generate a vector of random values [0.1, −0.05, 0.05] to a condensed dataset [1.2, 0.5, 0.4] to form the noise-altered condensed dataset [1.3, 0.45, 0.45]. The client device may then send the noise-altered condensed dataset to a server. Alternatively, in some embodiments, a receiving computing device may modify a condensed dataset with a set of noise values before storing the condensed dataset for further use in the process 300, such as updating a subset of condensed datasets with the noise-altered condensed dataset and distributing the noise-altered condensed dataset. Such noise-related modification of condensed data may help anonymize client-received data.

Some embodiments may update a subset of condensed datasets to include a first condensed dataset of the plurality of condensed datasets, as indicated by block 314. As described elsewhere, some embodiments may select a subset of the condensed datasets received from client devices for distribution to other client devices as part of a federated learning scheme. Some embodiments may select a first condensed dataset for use in the subset of datasets based on a determination that no other condensed datasets have been selected yet and that additional criteria are satisfied by the first condensed dataset. Such criteria may include a criterion that a first result matches with a second result, where the first result is an output of a prediction model provided with the first condensed dataset as an input, and where the second result is an output of a second prediction model provided with an uncondensed local dataset as an input, and where a client device generated the first condensed dataset using the uncondensed local dataset.

Some embodiments may determine whether an additional condensed dataset of the plurality of condensed datasets satisfies a set of criteria associated with the subset of condensed datasets, as indicated by block 318. In some embodiments, the set of criteria may include one or more criteria indicating that a first condensed dataset and a subsequent condensed dataset are sufficiently different. For example, some embodiments may include a candidate dataset in a subset of datasets for distribution to client devices in response to a determination of a result that a distance between the candidate dataset and a dataset that is already part of the subset of datasets for distribution satisfies a threshold. Other indicators of difference may be used and compared to the set of criteria.

Some embodiments may determine that a predictive learning model determined based on condensed data is sufficiently accurate relative to the accuracy of the predictive learning model when it uses non-condensed data. For example, a client device may perform a first training operation based on a received set of machine learning model parameters and local data to determine a first trained model, where the local data may be stored on the client device or otherwise accessible to the client device. The client device may then condense the local data into a condensed dataset and perform a second set of training operations to determine a second learning model result based on the condensed dataset. Some embodiments may then test the first condensed dataset to determine a first learning model result and test the second trained model to determine a second learning model result. The client device may then determine a model result difference based on a difference between the first learning model result and the second learning model result, where the difference may indicate an accuracy difference or some other type of difference. For example, the client device may determine the numeric value “0.94” using the first trained model and determine the numeric value “0.88” using the second trained model, where the numeric value may represent a confidence value associated with a prediction that an image includes a recognized category “card.”

In some embodiments, a client device may include other data usable to test the accuracy of a machine learning model, such as training data or validation data. Some embodiments may require a minimum degree of model accuracy in order to use associated condensed data. For example, a client device may determine a model accuracy value by providing a machine learning model local to the client device with one or more validation inputs, where the machine learning model is trained using a locally condensed dataset, and determining a model accuracy by comparing the outputs of the local machine learning model with validation outputs associated with the validation inputs. The client device may then send this model accuracy value associated with the locally condensed dataset to a server. Some embodiments may then compare the model accuracy value with a threshold and, based on a determination that the threshold is satisfied, indicate that the locally condensed dataset can be used to produce an accurate model. Some embodiments may then add the condensed dataset to a subset of datasets for distribution to other client devices.

Furthermore, some embodiments may determine a model result difference as a mean average or other measure of centralized tendency of other model result differences. As described elsewhere, a client device may provide a condensed dataset to a server for possible inclusion in a subset of condensed datasets for distribution. The client device may also use the condensed dataset to determine a model result difference and provide the model result difference to the server in association with the condensed dataset. Some embodiments may then use this model result difference to filter out models that are determined to be too inaccurate with respect to models trained on an uncondensed version of the data. For example, some embodiments may determine that a model result difference indicating an accuracy difference satisfies a model result threshold by being less than a maximum allowable accuracy difference and, in response, update the subset of condensed datasets to include the received condensed dataset. Alternatively, some embodiments may determine that the received model result difference is greater than a maximum allowable accuracy difference and, in response, not update the subset of condensed datasets with the received condensed dataset.

Some embodiments may use clustering operations when determining whether an additional condensed data satisfies a set of criteria associated with the subset of condensed datasets. In some embodiments, a server application may generate clusters of condensed datasets, where at least a portion of each condensed dataset may be used as vectors in a feature space representing the features of the condensed dataset. Some embodiments may perform clustering operations to determine clusters of condensed datasets in the feature space and determine centroids of the clusters. For each cluster, some embodiments may then select a number of condensed datasets to redistribute to other client devices or may select the centroid of the cluster to use as a synthetic condensed dataset to include a subset of condensed datasets to be distributed to client devices. For example, after receiving 1,000 condensed datasets, a server application may use a density-based clustering mechanism to determine a first cluster, a second cluster, and a third cluster. Some embodiments may then determine a first centroid of the first cluster, a second centroid of the second cluster, and a third centroid of the third cluster. In some embodiments, a server may then update a subset of condensed datasets indicated for distribution to include the first centroid, the second centroid, and the third centroid. Furthermore, some embodiments may select an additional condensed dataset from the same cluster for inclusion in a subset of condensed datasets assigned for distribution in response to determining that the additional condensed dataset is more than threshold distance away from a centroid of the cluster. For example, some embodiments may determine a cluster having a centroid at the position [3.4, 3.9, 1.2] in a feature space representing values of a condensed dataset. Some embodiments may then determine that a candidate condensed dataset is sufficiently far enough away from the centroid in the feature space and, in response, update a subset of condensed datasets to include the candidate condensed dataset.

Some embodiments may randomly select one or more condensed datasets to share by including the randomly selected datasets in a subset of condensed datasets to be distributed to client devices. For example, some embodiments may determine that no condensed datasets have been selected for distribution and, in response, randomly select a condensed dataset using a randomly generated value. Furthermore, some embodiments may still require that the randomly selected condensed dataset satisfies one or more criteria described in this disclosure.

Some embodiments may implement a set of time-related criteria that require that condensed data satisfy a data freshness requirement. For example, a client device may collect data associated with a first time interval (e.g., a set of transactions indicated to have occurred within the first time interval, a sequence of text tokens downloaded into the client device within the first time interval, a set of images indicated to have been downloaded or captured within the first time interval, etc.). In some embodiments, a client device may then generate a condensed dataset based on the collected data and provide the generated condensed dataset to a server in association with time-related data indicating the time interval. For example, a client device may condense local transaction data into a condensed dataset and provide, to a server, both the condensed dataset and two timestamps indicating the times of the first and last transactions of the local transaction data. Some embodiments may then determine whether the time interval satisfies a set of time criteria. For example, some embodiments may implement a set of time criteria that a first timestamp indicated to be the earliest transaction or otherwise the earliest timestamp associated with the time interval is later than a threshold. Alternatively, some embodiments may implement a set of time criteria that a second timestamp indicated to be the latest transaction or otherwise the latest timestamp associated with the time interval is later than a threshold. In response to determining a result indicating that the set of criteria is satisfied by a time interval or other time-related information associated with a first condensed dataset, some embodiments may permit the first condensed dataset to be added to a subset of condensed datasets to be distributed to other client devices. In response to determining a result indicating that the set of criteria is not satisfied by a time interval or other time-related information associated with a second condensed dataset, some embodiments may prevent the second condensed dataset from being selected for addition to a subset of condensed datasets to be distributed to other client devices.

Some embodiments may update the subset of condensed datasets to include the additional dataset, as indicated by block 320. As described elsewhere in this disclosure, some embodiments may add the additional dataset to the subset of condensed datasets. In some embodiments, the additional dataset may be optimized for transmission (e.g., changing a value from being stored as a floating-point number to being stored as an integer data type).

Some embodiments may determine whether an additional dataset is available for processing, as indicated by block 322. Some embodiments may obtain multiple condensed datasets and, for each respective dataset of the multiple condensed datasets, perform operations similar to or the same as those described for block 318 or block 320. Some embodiments may determine that no additional dataset is available for processing based a determination that all datasets of the additional datasets have been categorized as being included in the subset of condensed datasets or being excluded from the subset of condensed datasets.

Some embodiments may send the subset of condensed datasets to a set of client devices, as indicated by block 324. A server may send the subset of condensed datasets in various ways, such as by sending the subset of condensed datasets via a broadcast message that is then received by one or more client devices. In some embodiments, the server selects a specific subset of client devices to receive the subset of condensed datasets. For example, the server may determine that a first and second client device provided first and second datasets to a server, where the first and second datasets were added to a subset of condensed datasets. The server may then determine that a third client device did not provide any of the datasets included in the subset of condensed datasets and, in response, send the subset of condensed datasets to the third client device. Alternatively, or additionally, some embodiments may randomly select the third client device using a random or pseudorandom method. For example, some embodiments may generate a random value selected from a large group of values using a pseudorandom algorithmic generator or a physics-based random number generator, where each value of the group of values may represent an available client device. Some embodiments may then select the third client device to receive condensed datasets based on the random value.

Some embodiments may send a condensed dataset back to a client device for the client device to verify that the condensed dataset was generated by the client device. For example, some embodiments may receive an anomalous condensed dataset that triggers one or more anomaly criteria. Some embodiments may then send the anomalous condensed dataset back to the client device that originally provided the anomalous condensed dataset to verify if the condensed dataset is correct, where anomalies associated with the anomalous condensed dataset may indicate that one or more locally stored values are incorrect and require correction. In some embodiments, the client device may send a response to a server validating the previously sent condensed data. Alternatively, the client device may send a response to the server indicating that the previously sent condensed data is inaccurate or should otherwise not be used.

Some embodiments may obtain a set of model parameters or data derived from the set of model parameters from the set of client devices, as indicated by block 330. As described elsewhere, a client device may use a received subset of condensed data to train a machine learning model. For example, a client device may use a received subset of condensed user interface interaction data to train a local neural network to predict future user interface interactions. The client device may then send values indicating a number of nodes for each hidden layer, activation function parameters, weights, and biases of the local neural network to a server. Alternatively, the client device may receive an original set of model parameters, determine changes to the model parameters after performing a set of training operations using a received subset of condensed data, and send categorical or quantitative values indicating the changes from the original set of model parameters to the server. For example, in some embodiments, a client device may send a set of gradient values correlated with changes to a set of model parameters back to a server.

Some embodiments may update a server-side version of the machine learning model based on the set of model parameters or data derived from the set of model parameters provided by the set of client devices, as indicated by block 340. After receiving one or more model parameters from a set of client devices, a server or other set of computing devices may update a server-side model with the one or more model parameters via global aggregation. For example, the one or more model parameters may determine a mean average to an incoming set of model parameters or changes to the model parameters and update a preexisting set of model parameters for a global model with the mean average. Alternatively, some embodiments may use other methods, such as a federated stochastic gradient descent. For example, a set of client devices may provide gradients instead of weight updates based on training operations with a subset of condensed datasets. Some embodiments may then aggregate the gradients from different client devices and use the aggregated gradient to update a prediction model. Furthermore, as described elsewhere in this disclosure, a server may obtain parameters corresponding to multiple models from a set of client devices. The server may then update multiple server-side versions of the multiple models based on the parameters received from the set of client devices.

By updating a global model or other server-side model using selective condensed datasets, imbalances in the distribution of different types of condensed datasets may be overcome. The methods described in this disclosure can help prediction models provide accurate predictions for condensed datasets that are generated only in a minority of circumstances. Moreover, operations described in this disclosure may help preserve such accuracy gains without losing significant accuracy when predicting outputs based on a condensed dataset representing the majority of circumstances. Furthermore, because the use of selective condensed datasets effectively reduces the total number of training operations, some embodiments may dramatically reduce the energy consumption of training operations in a federated learning, which would have a corresponding effect on the amount of greenhouse gases being emitted to produce this energy. Though the reduction in greenhouse gas emission may be small for a single device, the effect on total greenhouse gas emission may be significant and impactful when scaled to multiple training operations across a large population of devices.

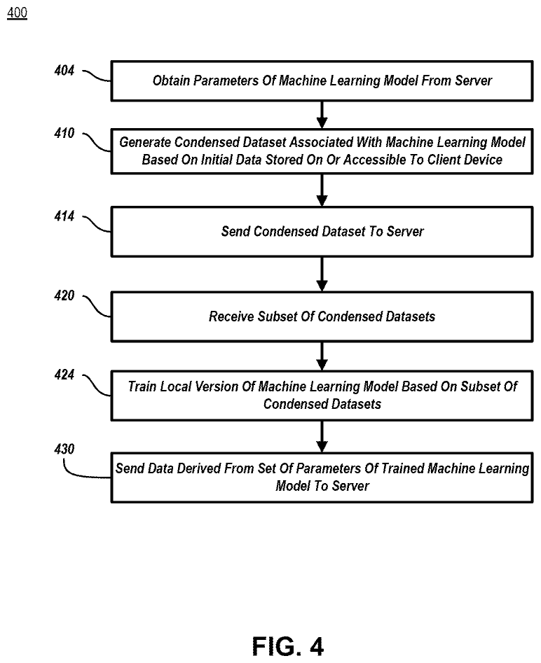

FIG. 4 is a flowchart of a process 400 for training a learning model with a client device that was provided with selectively determined condensed datasets, in accordance with one or more embodiments. Some embodiments may obtain, at a client device, parameters of a machine learning model from a server, as indicated by block 404. In some embodiments, a client device may be provided with an application that causes the client device to obtain a machine learning model via a set of network messages. Furthermore, an application executing on the application may obtain one or more updates to a set of machine learning model parameters, where the updates may change some or all of the values of the set of machine learning model parameters.

Some embodiments may generate a condensed dataset associated with the machine learning model based on initial data stored on or otherwise accessible to the client device, as indicated by block 410. Some embodiments may condense an initial locally stored dataset in one or more various ways to generate a condensed dataset, where a condensed dataset requires less memory than the initial locally stored dataset. Some embodiments may use a data condensation algorithm that is indicated by or updated by a server. For example, a server may provide a client device with a message that includes the values “Bin” and “5,” where receiving the message may cause the client device to initialize a binning operation that separates each value of an uncondensed dataset into one bin of a set of bins, where the set of bins segments a range of values of the uncondensed dataset.

It should be understood that different types of data condensation methods may be used without loss of generality. Some embodiments may use sampling algorithms such as a simple random sampling algorithm, a cluster sampling algorithm, or a systematic sampling algorithm to condense a larger dataset. Alternatively, or additionally, some embodiments may use a dimensional reduction algorithm such as a PCA algorithm, an LDA algorithm, or a set of auto encoders to perform dimensional production operations. It should be understood that some embodiments may provide model weights, biases, or other configuration parameters of an auto encoder to a client device, where the client device may use the auto encoder to condense data. Some embodiments may use binning algorithms to group data into bins or other types of categories. Furthermore, some embodiments may group datasets using clustering algorithms. Furthermore, in some embodiments, different client devices may use different data condensation methods to generate condensed data.

Some embodiments may send the condensed dataset to a server, as indicated by block 414. In some embodiments, a client device may send one or more condensed datasets to a server after generating the condensed dataset without a request from the server indicating a request for condensed data. Alternatively, the client device may send a set of condensed datasets to the server in response to a request from the server. Furthermore, some embodiments may send machine learning model updates to the server for comparison purposes.

Some embodiments may receive a subset of condensed datasets, as indicated by block 420. As described elsewhere, a server may select a subset of condensed datasets from a plurality of received condensed datasets and then send the subset of condensed datasets to one or more client devices for training operations. In some embodiments, a client device that first provided a first condensed dataset to a server may then receive a subset of condensed datasets from the server, where the first condensed dataset may be included in the subset of condensed datasets.

Alternatively, a client device that first provided a second condensed dataset to a server may then receive the subset of condensed datasets from the server, where the second condensed dataset is not included in the subset of condensed datasets.

Some embodiments may train a local version of the machine learning model based on the subset of condensed datasets, as indicated by block 424. In some embodiments, a client device may train a neural network using backpropagation methods to determine gradients based on a loss function, where one or more values of the received set of condensed datasets or data associated with the received set of condensed datasets may be used to determine the loss function. During such a training operation, some embodiments may then use an optimization algorithm, such as a gradient descent algorithm, to determine updates to the local version of the machine learning model. Furthermore, during training operations, some embodiments may use weights associated with a condensed dataset (e.g., a weight representing a count of datasets similar to the condensed dataset from other devices) to modify training operations. For example, some embodiments may determine a loss function and corresponding gradient using data provided by a first condensed dataset that is associated with a first weight value. Some embodiments may then modify the corresponding gradient based on the first weight value before using the modified gradient to determine a set of model parameter updates. Some embodiments may also implement regularization operations to prevent overfitting to condensed data.

Some embodiments may train multiple models based on a single received subset of condensed datasets. For example, some embodiments may train a first neural network model that is configured to predict a next search engine search term based on a subset of condensed datasets representing sequences of financial transactions from different client devices and train a second neural network model that is configured to predict a next transaction type based on the same subset of condensed datasets. By training multiple types of models on the same datasets, some embodiments may reduce the amount of data transfer required between devices and other computing systems to increase the efficiency of a federated architecture when performing one or more operations described in this disclosure.

Some embodiments may send data derived from a set of parameters of the trained machine learning model to the server, as indicated by block 430. As described elsewhere, a client device may send one or more parameters of a machine learning model to a server. In some embodiments, a client device may preserve its local version of the trained machine learning model for other applications. For example, after updating a machine learning model based on a set of condensed datasets indicating transaction data, the client device may keep the new parameters for the machine learning model that result from the training operations. Alternatively, some embodiments may discard the local version of the trained machine learning model. Furthermore, in some embodiments, data derived from a set of parameters of the trained machine learning model to the server may include the set of parameters of the trained machine learning model itself. Alternatively, or additionally, data derived from a set of parameters of the trained machine learning model may include differences from previously provided learning models, gradient values associated with the machine learning model, etc. Furthermore, a client device may train multiple models based on the same dataset and send parameters of the multiple models to the server. The server may then update multiple server-side models based on the received parameters.

The operations of each method presented in this disclosure are intended to be illustrative and non-limiting. It is contemplated that the operations or descriptions of FIG. 3 may be used with any other embodiment of this disclosure. In addition, the operations and descriptions described in relation to FIG. 3 may be done in alternative orders or in parallel to further the purposes of this disclosure. For example, each of these operations may be performed in any order, in parallel, or simultaneously to reduce lag or increase the speed of a computer system or method. In some embodiments, the methods may be accomplished with one or more additional operations not described, and/or without one or more of the operations discussed. Additionally, the order in which the processing operations of the methods are illustrated is not intended to be limiting. In some embodiments, a client device may directly perform one or more operations described in this disclosure as being performed by a server or other computing system. Furthermore, while some embodiments are described as determining a condensed dataset, sending a condensed dataset, selecting or otherwise determining a subset of condensed datasets, or training/updating models based the subset of condensed dataset, other embodiments may use other types of datasets to perform one or more operations described in this disclosure. For example, in some embodiments, a client device may send an uncondensed dataset of values stored on the client device, and a server may obtain a plurality of such datasets from different client devices and select a subset of datasets from this plurality of datasets.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a set of non-transitory, machine-readable media, such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods. For example, it should be noted that one or more of the devices or equipment discussed in relation to FIGS. 1-2 could be used to perform one or more of the operations described in relation to FIG. 3.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include a relational database such as a PostgreSQL™ database or MySQL database. Alternatively, or additionally, the set of databases or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communications networks or combination of communications networks. A network described by devices or systems described in this disclosure may include one or more communications paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “a element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

The present techniques will be better understood with reference to the following enumerated embodiments:

1. A method comprising: obtaining a plurality of datasets from a plurality of devices comprising a first device and a second device; updating a subset of datasets to comprise the first dataset; updating the subset of datasets to comprise a second dataset based on a result indicating that an indicator of difference between a first dataset and the second dataset satisfies a set of criteria; sending, to a third client device, the subset of datasets comprising the first dataset and the second dataset; obtaining, from the third client device, a set of model parameters that is derived from training based on the subset of datasets; and updating a second version of a machine learning model based on the set of model parameters.

2. The method of any of embodiment 1, wherein the plurality of datasets comprises the first dataset and the second dataset, and wherein the first dataset is provided by the first device, and wherein the second dataset is provided by the second device.

3. A method comprising: obtaining a plurality of condensed datasets from a plurality of client devices comprising a first client device and a second client device; updating a subset of condensed datasets to comprise the first condensed dataset; updating the subset of condensed datasets to comprise a second condensed dataset based on a result indicating that a feature space distance between a first condensed dataset and the second condensed dataset satisfies a set of criteria; sending, to a third client device, the subset of condensed datasets comprising the first condensed dataset and the second condensed dataset; obtaining, from the third client device, a set of model parameters that is derived from training based on the subset of condensed datasets; and updating a server version of a machine learning model based on the set of model parameters.

4. The method of any of embodiments 1 to 3, wherein the plurality of condensed datasets comprises the first condensed dataset and the second condensed dataset, and wherein the first condensed dataset is provided by the first client device, and wherein the second condensed dataset is provided by the second client device.

5. A method comprising: sending a machine learning model to data-sending devices of a federated learning structure; obtaining, from the data-sending devices, a plurality of condensed datasets at a server of the federated learning structure, wherein each respective condensed dataset of the plurality of condensed datasets is an input for a respective local version of the machine learning model; selecting a first condensed dataset for inclusion in a subset of condensed datasets provided by a first client device; determining that a feature space distance between the first condensed dataset and a second condensed dataset provided by a second client device exceeds a difference threshold; selecting the second condensed dataset for inclusion in the subset of condensed datasets in response to a determination that the feature space distance exceeds the difference threshold; sending the subset of condensed datasets comprising the first condensed dataset and the second condensed dataset to a data-receiving device, wherein the data-receiving device generates a set of learning model parameters from training based on the subset of condensed datasets; obtaining, from the data-receiving device, the set of learning model parameters derived from the training based on the subset of condensed datasets; and updating a server-side version of the machine learning model based on the set of learning model parameters.

6. A method comprising: providing parameters of a machine learning model to a plurality of client devices comprising a first client device, a second client device, and a third client device; obtaining a plurality of condensed datasets comprising a first condensed dataset provided by the first client device and a second condensed dataset provided by the second client device; updating a subset of condensed datasets to comprise the first condensed dataset; determining a result indicating that a feature space distance between the first condensed dataset and the second condensed dataset exceeds a threshold; updating the subset of condensed datasets to comprise the second condensed dataset in response to determining the result indicating that the feature space distance exceeds the threshold; sending, to the third client device, the subset of condensed datasets comprising the first condensed dataset and the second condensed dataset; obtaining, from the third client device, a set of model parameters that is derived from training based on the subset of condensed datasets; and updating a server-side version of the machine learning model based on the set of model parameters.

7. The method of any of embodiments 1 to 6, wherein: the first condensed dataset is provided in association with a model result difference indicating a difference in a learning model result based on the first condensed dataset and a second learning model result based on initial client data stored in the first client device; the method further comprises determining whether the model result difference satisfies a model result threshold; and updating the subset of condensed datasets to comprise the first condensed dataset comprises selecting the first condensed dataset based on a result indicating that the model result difference satisfies the model result threshold.

8. The method of any of embodiments 1 to 7, wherein providing the parameters of the machine learning model causes the first client device to condense local data stored in the first client device to generate the first condensed dataset.

9. The method of any of embodiments 1 to 8, further comprising adding noise to the subset of condensed datasets before sending the subset of condensed datasets to the third client device.

10. The method of any of embodiments 1 to 9, further comprising: generating a centroid of a cluster in a feature space based on the first condensed dataset and the second condensed dataset; and selecting an additional condensed dataset for inclusion in the subset of condensed datasets in response to determining a set of results indicating that the subset of condensed datasets is part of the cluster and is at least a threshold distance away from the centroid in the feature space, wherein sending the subset of condensed datasets to the third client device comprises sending the additional condensed dataset to the third client device.

11. The method of any of embodiments 1 to 10, further comprising sending, to the first client device, first data indicating a first data condensation algorithm, wherein receiving the first data indicating the first data condensation algorithm causes the first client device to generate the first condensed dataset using the first data condensation algorithm.

12. The method of any of embodiments 1 to 11, wherein: the first client device generates the first condensed dataset based on a first local dataset and a second local dataset; the first client device obtains the first local dataset during a first time interval; and the first client device obtains the second local dataset during a second time interval that is different from the first time interval.

13. The method of any of embodiments 1 to 12, wherein the first condensed dataset is selected based on a randomly generated value.

14. The method of any of embodiments 1 to 13, further comprising sending the subset of condensed datasets to at least one device of the first client device or the second client device.

15. The method of any of embodiments 1 to 14, wherein the subset of condensed datasets comprises a third condensed dataset, the method further comprising selecting the third condensed dataset based on a randomly generated value.

16. The method of any of embodiments 1 to 15, wherein updating the subset of condensed datasets to comprise the second condensed dataset comprises: performing a clustering operation based on the plurality of condensed datasets to generate a first cluster; determining that the second condensed dataset and the second condensed dataset are in the first cluster; and selecting the second condensed dataset comprises selecting the second condensed dataset in response to a result indicating that the second condensed dataset is in the first cluster.

17. The method of any of embodiments 1 to 16, wherein: the first condensed dataset is associated with a first location; the second condensed dataset is associated with a second location; and the method further comprises determining that the first condensed dataset and the second condensed dataset satisfy a distance threshold, wherein updating the subset of condensed datasets to comprise the second condensed dataset comprises selecting the second condensed dataset in response to a determination that the first condensed dataset and the second condensed dataset satisfy the distance threshold.

18. The method of any of embodiments 1 to 17, the method further comprising selecting, as a destination for the subset of condensed datasets, the third client device based on a randomly generated value.

19. The method of any of embodiments 1 to 18, wherein obtaining the plurality of condensed datasets comprises stochastically sending a command to the plurality of client devices, wherein receiving the command causes the plurality of client devices to transmit the plurality of condensed datasets.

20. The method of any of embodiments 1 to 19, the method further comprising determining a noise value, wherein sending the subset of condensed datasets comprises updating a value of the first condensed dataset based on the noise value.

21. The method of any of embodiments 1 to 20, wherein: obtaining the plurality of condensed datasets comprises obtaining a model accuracy value associated with the first condensed dataset; the method further comprises determining whether the model accuracy value satisfies a threshold; and updating the subset of condensed datasets to comprise the first condensed dataset comprises selecting the first condensed dataset based on a result indicating that the model accuracy value satisfies the threshold.

22. The method of any of embodiments 1 to 21, wherein: the first client device generates the first condensed dataset based on a first local dataset; the first client device obtains the first local dataset during a first time interval; determining whether the first time interval satisfies a set of time criteria; and updating the subset of condensed datasets to comprise the first condensed dataset comprises selecting the first condensed dataset based on a result indicating that the first time interval satisfies the set of time criteria.

23. The method of embodiment 22, wherein: obtaining the plurality of condensed datasets comprises obtaining an additional condensed dataset from a fourth client device; the fourth client device generates the additional condensed dataset based on a second local dataset that is accessible to the fourth client device; the first client device obtains the second local dataset during a second time interval; determining whether the second time interval satisfies the set of time criteria; and not selecting the additional condensed dataset for inclusion in the subset of condensed datasets based on a result indicating that the second time interval does not satisfy the set of time criteria.

24. The method of any of embodiments 1 to 23, wherein the set of model parameters is a first set of model parameters, and wherein the machine learning model is a first machine learning model, further comprising: receiving a second set of model parameters that is derived from training based on the subset of condensed datasets to update a local version of a second machine learning model; and updating a server-side version of the second machine learning model based on the second set of model parameters.

25. One or more tangible, non-transitory, machine-readable media storing instructions that, when executed by a set of processors, cause the set of processors to effectuate operations comprising those of any of embodiments 1 to 24.

26. A system comprising: a set of processors and a set of media storing computer program instructions that, when executed by the set of processors, cause the set of processors to effectuate operations comprising those of any of embodiments 1 to 25.

What is claimed is:

1. A system for training a machine learning model using a federated learning structure by selectively sharing condensed data between devices to reduce energy consumption, the system comprising one or more processors and one or more non-transitory, machine-readable media storing program instructions that, when executed by the one or more processors, cause operations comprising:
sending a machine learning model to data-sending devices of a federated learning structure;
obtaining, from the data-sending devices, a plurality of condensed datasets at a server of the federated learning structure, wherein each respective condensed dataset of the plurality of condensed datasets is an input for a respective local version of the machine learning model;
selecting a first condensed dataset for inclusion in a subset of condensed datasets provided by a first client device;
determining that a feature space distance between the first condensed dataset and a second condensed dataset provided by a second client device exceeds a difference threshold;
selecting the second condensed dataset for inclusion in the subset of condensed datasets in response to a determination that the feature space distance exceeds the difference threshold;
sending the subset of condensed datasets comprising the first condensed dataset and the second condensed dataset to a data-receiving device, wherein the data-receiving device generates a set of learning model parameters from training based on the subset of condensed datasets;
obtaining, from the data-receiving device, the set of learning model parameters derived from the training based on the subset of condensed datasets; and
updating a server-side version of the machine learning model based on the set of learning model parameters.

2. A method comprising:
providing parameters of a machine learning model to a plurality of client devices comprising a first client device, a second client device, and a third client device;
obtaining a plurality of condensed datasets comprising a first condensed dataset provided by the first client device and a second condensed dataset provided by the second client device;
updating a subset of condensed datasets to comprise the first condensed dataset;
determining a result indicating that a feature space distance between the first condensed dataset and the second condensed dataset exceeds a threshold;
updating the subset of condensed datasets to comprise the second condensed dataset in response to determining the result indicating that the feature space distance exceeds the threshold;
sending, to the third client device, the subset of condensed datasets comprising the first condensed dataset and the second condensed dataset;
obtaining, from the third client device, a set of model parameters that is derived from training based on the subset of condensed datasets; and
updating a server-side version of the machine learning model based on the set of model parameters.

3. The method of claim 2, wherein:
the first condensed dataset is provided in association with a model result difference indicating a difference in a learning model result based on the first condensed dataset and a second learning model result based on initial client data stored in the first client device;
the method further comprises determining whether the model result difference satisfies a model result threshold; and
updating the subset of condensed datasets to comprise the first condensed dataset comprises selecting the first condensed dataset based on a result indicating that the model result difference satisfies the model result threshold.

4. The method of claim 2, wherein providing the parameters of the machine learning model causes the first client device to condense local data stored in the first client device to generate the first condensed dataset.

5. The method of claim 2, further comprising adding noise to the subset of condensed datasets before sending the subset of condensed datasets to the third client device.

6. The method of claim 2, further comprising:
generating a centroid of a cluster in a feature space based on the first condensed dataset and the second condensed dataset; and
selecting an additional condensed dataset for inclusion in the subset of condensed datasets in response to determining a set of results indicating that the subset of condensed datasets is part of the cluster and is at least a threshold distance away from the centroid in the feature space, wherein sending the subset of condensed datasets to the third client device comprises sending the additional condensed dataset to the third client device.

7. The method of claim 2, further comprising sending, to the first client device, first data indicating a first data condensation algorithm, wherein receiving the first data indicating the first data condensation algorithm causes the first client device to generate the first condensed dataset using the first data condensation algorithm.

8. The method of claim 2, wherein:
the first client device generates the first condensed dataset based on a first local dataset and a second local dataset;
the first client device obtains the first local dataset during a first time interval; and
the first client device obtains the second local dataset during a second time interval that is different from the first time interval.

9. The method of claim 2, wherein the first condensed dataset is selected based on a randomly generated value.

10. The method of claim 2, further comprising sending the subset of condensed datasets to at least one device of the first client device or the second client device.

11. One or more non-transitory, machine-readable media storing program instructions that, when executed by one or more processors, perform operations comprising:
obtaining a plurality of condensed datasets from a plurality of client devices comprising a first client device and a second client device, wherein the plurality of condensed datasets comprises a first condensed dataset provided by the first client device and a second condensed dataset provided by the second client device;
updating a subset of condensed datasets to comprise the first condensed dataset;
updating the subset of condensed datasets to comprise the second condensed dataset based on a result indicating that a feature space distance between the first condensed dataset and the second condensed dataset satisfies a set of criteria;
sending, to a third client device, the subset of condensed datasets comprising the first condensed dataset and the second condensed dataset;
obtaining, from the third client device, a set of model parameters that is derived from training based on the subset of condensed datasets; and
updating a server version of a machine learning model based on the set of model parameters.

12. The one or more non-transitory, machine-readable media of claim 11, wherein the subset of condensed datasets comprises a third condensed dataset, the operations further comprising selecting the third condensed dataset based on a randomly generated value.

13. The one or more non-transitory, machine-readable media of claim 11, wherein updating the subset of condensed datasets to comprise the second condensed dataset comprises:
performing a clustering operation based on the plurality of condensed datasets to generate a first cluster;
determining that the second condensed dataset and the second condensed dataset are in the first cluster; and
selecting the second condensed dataset comprises selecting the second condensed dataset in response to a result indicating that the second condensed dataset is in the first cluster.

14. The one or more non-transitory, machine-readable media of claim 11, wherein:
the first condensed dataset is associated with a first location;
the second condensed dataset is associated with a second location; and
the operations further comprise determining that the first condensed dataset and the second condensed dataset satisfy a distance threshold, wherein updating the subset of condensed datasets to comprise the second condensed dataset comprises selecting the second condensed dataset in response to a determination that the first condensed dataset and the second condensed dataset satisfy the distance threshold.

15. The one or more non-transitory, machine-readable media of claim 11, the operations further comprising selecting, as a destination for the subset of condensed datasets, the third client device based on a randomly generated value.

16. The one or more non-transitory, machine-readable media of claim 11, wherein obtaining the plurality of condensed datasets comprises stochastically sending a command to the plurality of client devices, wherein receiving the command causes the plurality of client devices to transmit the plurality of condensed datasets.

17. The one or more non-transitory, machine-readable media of claim 11, the operations further comprising determining a noise value, wherein sending the subset of condensed datasets comprises updating a value of the first condensed dataset based on the noise value.

18. The one or more non-transitory, machine-readable media of claim 11, wherein:
obtaining the plurality of condensed datasets comprises obtaining a model accuracy value associated with the first condensed dataset;
the operations further comprise determining whether the model accuracy value satisfies a threshold; and
updating the subset of condensed datasets to comprise the first condensed dataset comprises selecting the first condensed dataset based on a result indicating that the model accuracy value satisfies the threshold.

19. The one or more non-transitory, machine-readable media of claim 11, wherein:
the first client device generates the first condensed dataset based on a first local dataset;
the first client device obtains the first local dataset during a first time interval;
determining whether the first time interval satisfies a set of time criteria; and
updating the subset of condensed datasets to comprise the first condensed dataset comprises selecting the first condensed dataset based on a result indicating that the first time interval satisfies the set of time criteria.

20. The one or more non-transitory, machine-readable media of claim 19, wherein:
obtaining the plurality of condensed datasets comprises obtaining an additional condensed dataset from a fourth client device;
the fourth client device generates the additional condensed dataset based on a second local dataset that is accessible to the fourth client device;
the first client device obtains the second local dataset during a second time interval;
determining whether the second time interval satisfies the set of time criteria; and
not selecting the additional condensed dataset for inclusion in the subset of condensed datasets based on a result indicating that the second time interval does not satisfy the set of time criteria.
